(19) United States
(12) Patent Application Publication
(10) Pub. No.: US 2006/0228934 A1
(43) Pub. Date: Oct. 12, 2006

(54) Conductive materials for low resistance interconnects and methods of forming the same

(76) Inventor: Bulent M. Basol, Manhattan Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/351,914

(22) Filed: Feb. 9, 2006

Related U.S. Application Data
(60) Provisional application No. 60/670,800, filed on Apr. 12, 2005.

(51) Int. Cl. H01R 12/24

(52) U.S. Cl. 439/495

(57) ABSTRACT

Openings or features of small and large sizes are provided on a partially fabricated integrated circuit. The small openings are completely filled by electrodeposition of a first, low-resistivity material such as silver. The same deposition only partially fills the larger openings. A subsequent electrodeposition of a second metal, such as copper, fills the remainder of the larger features. While more highly resistive, the copper is much cheaper and resistivity is not as critical for these larger openings, which may represent bond pads or conductive lines, whereas the smaller features may represent more critical features such as small lines in an array for which high resistivity is more important, despite the expense.

### REFERENCE TO RELATED APPLICATIONS

The present application claims priority under 35 U.S.C. § 119(e) to U.S. provisional application No. 60/670,800, filed Apr. 12, 2005 (attorney docket no. ASMNUT.134PR).

### FIELD OF INVENTION

The invention relates to manufacture of semiconductor integrated circuits and, more particularly to methods for depositing conductive materials on wafers for integrated circuit interconnect applications and structures formed by such methods.

### BACKGROUND

Conventional semiconductor devices generally include a semiconductor substrate, such as a silicon substrate, and a plurality of sequentially formed dielectric interlayers such as silicon dioxide and conductive paths or interconnects made of conductive materials. Copper (Cu) and copper-alloys have received considerable attention as interconnect materials because of their superior electro-migration and low resistivity characteristics. In copper interconnect technology, interconnects are usually formed by filling copper in features or cavities etched into the dielectric layers by a metallization process. The preferred method of copper metallization is electroplating. In an integrated circuit, multiple vertical levels of interconnect networks laterally or horizontally extend with respect to the substrate surface. Interconnects formed in sequential layers can be electrically connected vertically using vias or contacts.

In a typical interconnect manufacturing process, first an insulating layer is formed on a semiconductor substrate. Patterning and etching processes are performed to form features or cavities such as trenches and vias in the insulating layer. In the following step, a barrier/glue layer and a seed layer are coated over the patterned surface, and a conductor such as copper is electroplated to fill all the features. Although copper is a good conductor for interconnect applications, ever decreasing feature sizes affect conductivity or sheet resistance of the copper within sub-100 nm wide trenches and vias. As the feature size, i.e., feature width, approaches 45 nm and beyond, electrical sheet resistance of the copper interconnects formed in such features also increases sharply due to smaller grains and scattering from the feature walls. This is referred to as the size effect in the field of interconnect technologies.

To solve the size effect and the high resistivity problems for future technology nodes, more suitable conductive materials and alternative deposition techniques are needed in the interconnect manufacturing technologies to assure that line and via resistances are at acceptable levels.

### SUMMARY

In accordance with one aspect of the invention, a method is provided for depositing metal layers for an integrated circuit. The method includes providing a substrate having a plurality of open first features and a plurality of open second features, wherein the second features have greater widths than the first features. A first metal is plated onto the substrate, where the first metal completely fills the first features and only partially fills the second features. A second metal is plated onto the first metal, where the second metal fills unfilled portions of the second features, wherein the first metal has a lower resistivity than the second metal.

In accordance with another aspect of the invention, a process is provided for filling features on a substrate for semiconductor device fabrication. The process includes providing a substrate having an insulating layer with the features formed therein. The features include small features having widths of less than 100 m and larger features having widths greater than the widths of the small features. A first metal is deposited into the larger and small features, the first metal completely filling the small features and partially filling the larger features. A second metal is deposited directly onto the first metal, the second metal filling a remaining unfilled portion of the larger features and having a conductivity less than a conductivity of the first metal.

In accordance with another aspect of the invention, an integrated circuit has a metallization level including a plurality of small features and a plurality of larger features. A first metal completely fills the small features and only partially fills the larger features. A second metal fills a remaining portion of the larger features on top of the first metal, wherein the first metal has a lower resistivity than the first metal.

In accordance with another aspect of the invention, a method is provided for filling features on a surface of a wafer with a first conductor having a first conductivity. The first conductor completely fills features having less than 100 nm width while partially filling features having more than 100 nm width. A second conductor having a second conductivity less than the first conductivity is deposited onto the first conductor to completely fill the features having more than 100 nm width.

### BRIEF DESCRIPTION OF THE DRAWINGS

FIGS. 1-4 are schematic cross-sectional views of a partially fabricated integrated circuit, showing stages of processing in accordance with a preferred embodiment of the present invention.

FIG. 5 is a schematic plan view of a process tool in accordance with a preferred embodiment.

### DETAILED DESCRIPTION

The process described herein provides an interconnect conductor deposition method for filling the small features on a substrate surface with a material with a high electrical conductivity, or low electrical resistivity. High conductivity material can be a noble metal or a metal or alloy that has a lower resistivity than copper, including superconductive materials. Silver (Ag) is an exemplary noble metal having a lower resistivity value (1.629 μΩ·cm at 300K) than copper (1.725 μΩ·cm at 300K). Furthermore, silver resistivity increases at a smaller rate as the temperature is increased compared to copper resistivity. Silver, therefore, may replace copper to lower the sheet resistance of the interconnect structures. Furthermore, in general, materials displaying a smaller size effect in small features are appropriate for lowering the overall sheet resistance of the interconnect structures, especially within cavities with widths of 65 nm or smaller. These materials, however, are much more expensive than copper and their use would make interconnects too costly. Therefore, the process described herein aims at lowering the manufacturing cost of interconnects by utilizing a multi-step deposition process wherein the expensive but high conductivity material or materials are deposited first on the substrate surface to fill in the smallest features where the size effect and the high sheet resistance problems are the worst; then the lower conductivity but low cost material or materials are deposited to fill the larger features that experience less significant size effect and high sheet resistance problems.

In a preferred embodiment of the present invention, in an initial deposition step at least the smallest features, with widths of 100 nm or smaller, preferably 65 nm or smaller, on a substrate are completely filled with a high conductivity material such as silver, while the remaining larger features at the same stage or level are only partially filled with the same high conductivity material. In the second process step a less conductive but lower cost material is deposited on the high conductivity material layer that was deposited during the first step. In the second step, the partially filled larger features are preferably completely filled with the less conductive but lower cost conductive material, such as copper or copper alloys. The preferred method of deposition is plating, and particularly electroplating. However, other deposition techniques such as electroless plating and chemical vapor deposition methods may also be utilized, as long as they have the capability to fill the smallest features without voids or other defects. The electroplating process may be performed in multiple sequential steps in different electroplating modules with different process solutions containing different conductive materials. Alternatively, one plating module may be used by changing the plating solution for the two sequential process steps: a first solution is used during the initial plating step, the first solution comprising the high conductivity material such as silver; then a second solution is provided to the plating cell for the second process step, the second solution comprising the less conductive material such as copper.

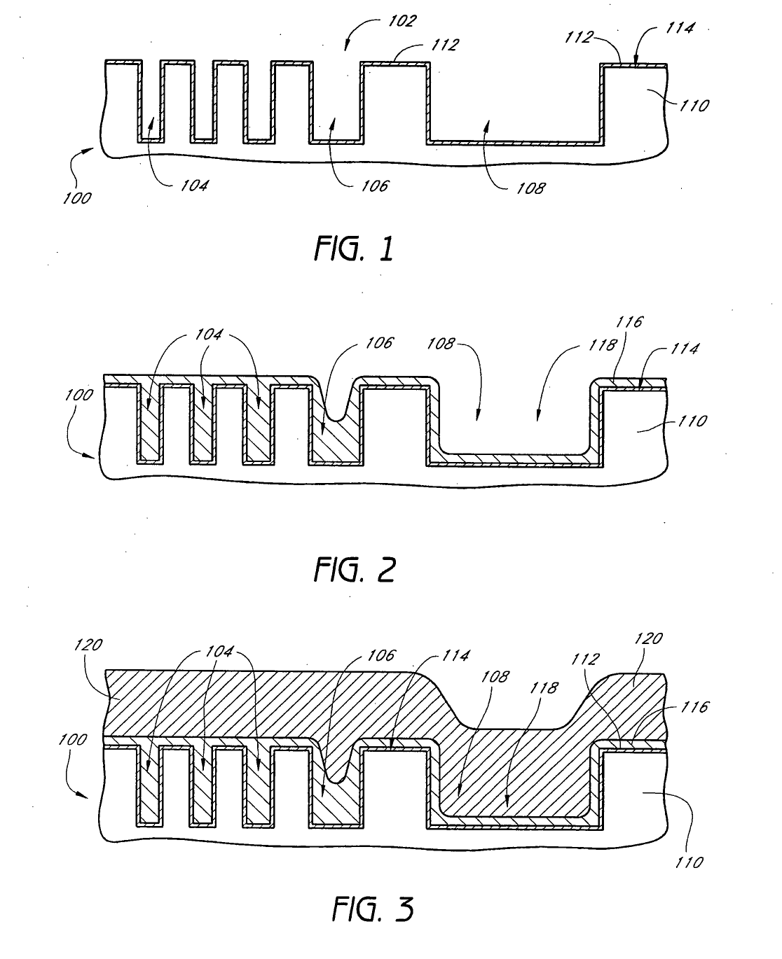

FIG. 1 shows a substrate 100 having a surface 102. The substrate may represent an exemplary portion of a partially fabricated integrated circuit on a workpiece (e.g., a silicon wafer), which has been pre-processed by photolithography, etching etc., before depositing an interconnect conductor. The surface 102 may include first features such as the illustrated small features 104, and second features such as an illustrated mid-size feature 106 and a large feature 108 to house the conductor. As an example of demarcations among the sizes of the features, the small size features may have a width of less than 100 nm and preferably less than 65 nm while the width of the mid-size features is greater than 65 nm and may range from 100 nm to 5 microns. The large feature 108 may have a width larger than 1 micron, often exceeding 5 microns. In this example, the small features 104 are grouped to form a high density feature area on the substrate, such as a memory or logic array. As described before and will be explained more fully below, interconnects comprising small features 104 are prone to the above-mentioned resistivity problems; therefore, using the present process, they can be advantageously filled with conductors having smaller resistivities in a cost effective way. The features 104, 106 and 108 may be formed in an insulating layer 110 of the substrate 100. A barrier layer 112 formed of diffusion barrier materials like Ta, TaN, WCN, Ru or stacks of such materials, such as Ta/TaN, Ta/Ru, WCN/Ru etc., are coated onto the inside surface of the features and the top surface 114 of the insulating layer 110 before the conductor deposition. It will be understood that the barrier layer or stack 112 can serve diffusion barrier, contact resistance lowering and/or adhesion functions, but in any case is preferably conductive. A metallic seed layer (not shown), such as a thin copper layer or a thin silver layer, is coated on the barrier layer 112 by high conformality techniques such as atomic layer deposition, chemical vapor deposition or physical vapor deposition.

As shown in FIGS. 2 and 3, the electroplating process of the preferred embodiments is performed in at least two plating steps. In the first step of the process, a trade-off is established between the use of the high conductivity material and the cost of it so that the high conductivity material only fills the smallest features on the surface, with widths that are less than 100 nm, which conventionally experience sheet resistance or resistivity problems as well as the size effect problem. The resistivity problem in features over 100 nm width is less significant; and therefore, such features need not be completely filled with the high conductivity material. Accordingly, the expensive material is used where it is needed the most. In that respect, to further cut costs the first deposition step may only be limited to completely filling only features that are 65 nm or less in width. As will be understood by the skilled artisan, a high aspect ratio feature is typically filled by deposition thickness about half of the feature's width, although electroplating additives can further reduce the thickness needed due to bottom-up fill phenomenon. Low aspect ratio features, on the other hand, are typically filled by deposition thickness of about the depth of the features.

Referring back to FIG. 2, in the first step of the process a high cost and high conductivity material is filled into the small features 104 and then this step of the process is terminated. During the first step of the process electrolyte formulations with well known “bottom-up fill” capability are used. For example, if the high conductivity material is silver, a silver plating electrolyte with organic additives such as accelerators and suppressors is utilized so that the small features 104 can be filled by depositing a very thin silver layer. For example, to bottom-up fill exemplary small features with a width of 65 nm, only 10-30 nm thick silver may be deposited on the surface of the substrate and this would be adequate to fill the small features 104, as shown in FIG. 2. Such an approach is very cost effective since very little silver is used in the process. It should be noted that as the small features are filled during the first step of the process, the medium size features 106 would only be partially filled with silver. The large features 108, on the other hand, would only be lined with the thin (e.g., 10-30 nm thick) silver film. In the second plating step of the process, remaining unfilled portions of the medium size and large features 106, 108 and any other features on wafer surface are filled with a less expensive conductor such as copper to complete the process. It should be noted that amount of the less expensive copper used in the process is much higher than the expensive silver used to fill the small size features 104.

Specifically, as illustrated in FIG. 2, in the first step of the process, a first conductor layer 116 is formed on the substrate 100, the first conductor forming a low sheet resistance structure in the smallest features, preferably after an annealing step at a temperature of 150-450° C. The first conductor layer 116 is preferably formed by electrodepositing a first conductor onto the substrate. In this embodiment, the first conductor forming the first conductor layer 116 is preferably silver. Referring to FIG. 2, before the first step of the electroplating process ends, the first conductor completely fills the small size features 104; partially fills the mid-size feature 106; and conformally coats the large size feature 108. The first conductor fills the small and mid-size features in bottom-up fashion but conformally coats the large feature because of its large width, leaving a step 118 or a cavity in the large feature 108. The first conductor layer 116 is formed using only an adequate amount of the first conductor to keep the cost down. The deposition of the first conductor is halted as soon as the first conductor fills the small size features 104 so as not to waste expensive material. Excess material deposition over the top surface 114 of the insulating layer 110 is preferably removed during a subsequent planarization step, such as chemical mechanical polishing and electropolishing (including electrochemical mechanical polishing), that normally follows a plating process, with a commonly used annealing step between the two. Preferably the annealing and planarization follows the second plating step described below.

As illustrated in FIG. 3, once the first step of the plating process is completed, a second conductor layer 120 is formed on the first conductor layer 116. The second conductor layer 120 is preferably formed by depositing a second conductor onto the first conductor layer 116 to fill the step 118 and other recesses on the first conductor layer 116 which are below the top surface 114 of the insulating layer 110. The second conductor is preferably copper or an alloy of copper (e.g., with silver), which is less expensive than the first conductor, although copper and its alloys demonstrate slightly higher electrical resistivity. However, as it is mentioned above, the effect of such electrical resistivity is not significant in features having widths larger than about 65 nm, especially larger than 100 nm.

Once the plating process of the present invention is completed, the excess conductor on the top surface 114 of the dielectric can be removed by a planarization technique such as chemical mechanical polishing (CMP) or electrochemical mechanical polishing (ECMP). As shown in FIG. 4, after the planarization, the small size features include only first conductor deposits 116A; the mid-size features 106 and large size features 108 include first conductor deposits 116A and second conductor deposits 120A. The second conductor deposits represent a majority of the volume of the large size features 108 in the illustrated embodiment. An anneal step may also be carried out before and/or after the planarization step.

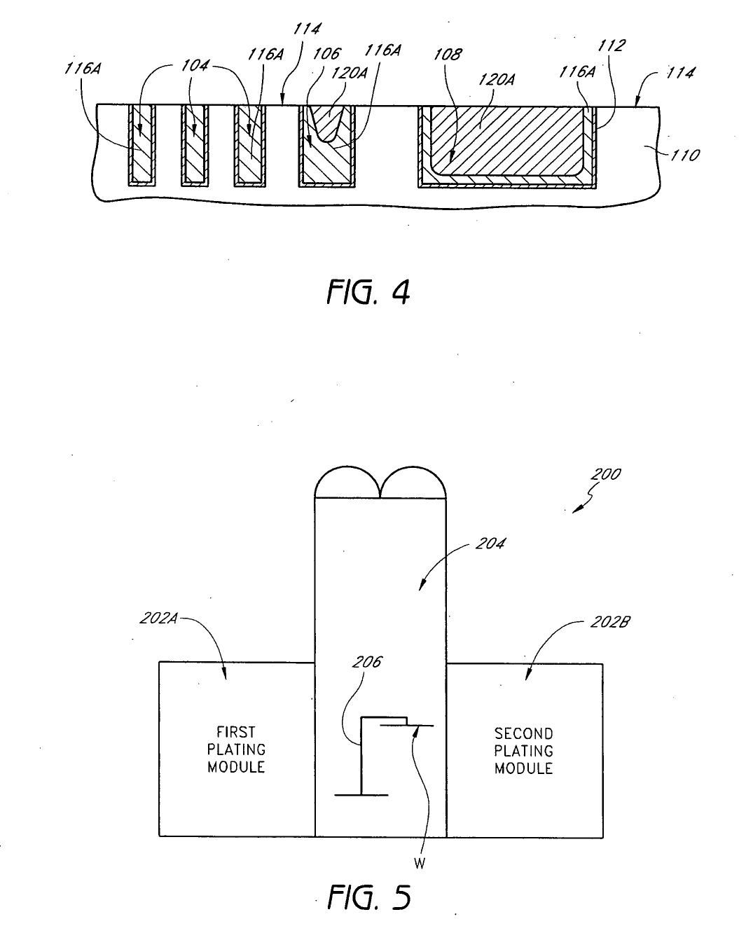

FIG. 5 exemplifies a cluster tool or system 200 configured to perform above described two step plating process. As will be appreciated by the skilled artisan, the system 200 will include control systems programmed to perform the described sequence. The system 200 includes multiple modules, such as a first module 202A and a second module 202B separated by a delivery section 204. One or more robots 206 in the delivery section 204 transfer wafers W to and from modules 202 or between the modules 202, and takes them out when the process is complete. In this exemplary configuration, the first and second modules 202A and 202B are electrochemical deposition (ECD) modules to perform the first plating step and second plating step of the plating process. Principles of electrochemical plating are well-known in interconnect technologies. In an exemplary process sequence, the wafer W is first delivered to the first plating module 202A for the first plating process step described above. For clarity, it is assumed that the surface of the wafer W includes the structure shown in FIG. 1. In the first module 202A, the first conductor layer 116 shown in FIG. 2 is formed using an electrochemical process. The first conductor is deposited onto the surface of the wafer W from a first process solution. The first process solution is preferably a silver plating electrolyte, such as a cyanide electrolyte comprising KAg(CN)₂, potassium cyanide and potassium carbonate. There are also non-cyanide silver plating solutions based on silver iodide, silver thiosulfate, or potassium silver disuccinimide among others. During the electrochemical process, a potential difference is applied between an electrode (not shown) and the surface of the wafer W. After completing the first plating step, the wafer W is transferred to the second plating module 202B. In the second module 202B, the second conductor layer 120 shown in FIG. 3 is formed using an electrochemical process. The second conductor is deposited onto the surface of first conductor layer 116 from a second process solution. The second process solution is preferably a copper or copper alloy plating electrolyte, such as copper sulfate based solutions available from Rohm and Haas and Enthone Co.

After the plating process, the wafer may be taken to a planarization module and planarized to remove the excess conductors from its top surface, leaving conductive material only within the cavities. It is preferable to anneal the wafer after the second deposition step to enhance grain growth in the conductor layers and to reduce the sheet resistance further.

It will be appreciated by those skilled in the art that various omissions, additions and modifications made be made with the processes described above without departing from the scope of the invention, and all such modifications and changes are intended to fall within the scope of the invention, as defined by the appended claims.

1. A method of depositing metal layers for an integrated circuit, comprising:
providing a substrate having a plurality of open first features and a plurality of open second features, wherein the second features have greater widths than the first features;
plating a first metal onto the substrate, the first metal completely filling the first features and only partially filling the second features; and
plating a second metal onto the first metal, the second metal filling unfilled portions of the second features, wherein the first metal has a lower resistivity than the second metal.

2. The method of claim 1, wherein the first metal comprises a noble metal.

3. The method of claim 2, wherein the first metal comprises silver and the second metal comprises copper.

4. The method of claim 3, wherein the second metal comprises a copper alloy.

5. The method of claim 1, wherein the first features have a width less than 100 nm.

6. The method of claim 5, wherein the first features have a width less than 65 nm.

7. The method of claim 1, wherein the second features comprise mid-size features having widths greater than 65 nm, and the second features further comprise large size features having widths greater than 1 micron.

8. The method of claim 7, wherein the large size features have widths larger than 5 microns.

9. The method of claim 8, wherein plating the first metal comprises lining the large features with the first metal.

10. The method of claim 7, wherein the mid-size features have widths larger than 100 mm.

11. The method of claim 1, wherein plating the first metal comprises electrochemical deposition.

12. The method of claim 1, wherein plating the second metal comprises electrochemical deposition.

13. A process for filling features on a substrate for semiconductor fabrication, the process comprising:
providing a substrate having an insulating layer with the features formed therein, the features including small features having widths of less than 100 nm and larger features having a width greater than the widths of the small features;
depositing a first metal into the larger and small features, the first metal completely filling the small features and partially filling the larger features; and
depositing a second metal directly onto the first metal, the second metal filling a remaining unfilled portion of the larger features and having a conductivity less than a conductivity of the first metal.

14. The process of claim 13, wherein the first metal comprises a noble metal.

15. The process of claim 14, wherein the first metal comprises silver.

16. The method of claim 13, wherein the first metal has a resistivity lower than 1.725 μΩ·cm at 300 K.

17. The process of claim 16, wherein the second metal comprises copper.

18. The process of claim 17, wherein the second metal comprises a copper alloy.

19. The process of claim 13, wherein depositing the first metal comprises plating.

20. The process of claim 19, wherein depositing the first metal comprises electrochemical deposition.

21. The process of claim 13, wherein depositing the second metal comprises plating.

22. The process of claim 21, wherein depositing the second metal comprises electrochemical deposition.

23. The process of claim 13, wherein the larger features comprise a plurality of mid-size features having widths greater than 65 nm and a plurality of larger size features having widths greater than 1 micron.

24. The process of claim 23, wherein the larger size features have widths greater than 5 microns.

25. The process of claim 23, wherein the mid-size features have widths greater than 100 nm.

26-33. (canceled)

34. A method of filling features on a surface of a wafer, comprising:
filling features with a first conductor having a first conductivity, the first conductor completely filling features having less than 100 nm width while partially filling features having more than 100 nm width; and
depositing a second conductor having a second conductivity less than the first conductivity onto the first conductor to completely fill the features having more than 100 nm width.

35. The method of claim 34, wherein filling forms a first conductor layer on the surface of the wafer.

36. The method of claim 34, wherein depositing forms a second conductor layer on the surface of the wafer.

37. The method of claim 34, wherein filling comprises electrochemical deposition.

38. The method of claim 34, wherein filling comprises chemical vapor deposition.

39. The method of claim 34, wherein filling comprises electroless deposition.

40. The method of claim 34, wherein depositing comprises electrochemical deposition.

41. The method of claim 34, wherein depositing comprises chemical vapor deposition.

42. The method of claim 34, wherein depositing comprises electroless deposition.

43. The method of claim 34, wherein the first conductor is silver.

44. The method of claim 34, wherein the second conductor is copper.

45. The method of claim 34, wherein the first conductor comprises a superconductive material.
